(19) United States
(12) Patent Application Publication
(10) Pub. No.: US 2026/0304086 A1
(43) Pub. Date: Oct. 1, 2026

(54) High Bitrate Audio Wireless Communication

(71) Applicant: Google LLC, Mountain View, CA (US)

(72) Inventor: Sunil Kumar, Cupertino, CA (US)

(21) Appl. No.: 19/474,983

(22) PCT Filed: Apr. 15, 2024
(86) PCT No.: PCT/US2024/024610

§ 371 Date: Oct. 13, 2025

Related U.S. Application Data
(60) Provisional application No. 63/460,542, filed on Apr. 19, 2023.

(51) Int. Cl. H04W 4/80; G06F 3/16; G10L 19/008; H04M 1/60; H04R 5/033; H04R 5/04

(52) U.S. Cl. CPC H04W 4/80; G06F 3/162; G10L 19/008; H04M 1/6066; H04R 5/033; H04R 5/04; H04R 2420/07

(57) ABSTRACT

Various arrangements are presented that can help preserve bandwidth, such as for audio communications involving high fidelity audio being transmitted to wireless earbuds. A first earbud can receive an audio packet from an audio source device that includes stereo audio separately encoded as a first monophonic channel and a second monophonic channel. The first earbud can determine that it successfully received the audio packet. The second earbud may not successfully receive the audio packet. Thus, the second earbud can make a request to the first earbud. The first earbud can then directly transmit to the second earbud, audio data for only the second monophonic channel from the audio packet. Each earbud can then output its respective monophonic audio channel.

### CROSS-REFERENCE TO RELATED APPLICATION

This application claims the benefit of and priority to U.S. Provisional Application No. 63/460,542, filed on Apr. 19, 2023, and titled “OPTIMIZING BANDWIDTH USAGE FOR HIGH BITRATE AUDIO APPLICATIONS, INCLUDING HIGH RESOLUTION AUDIO,” the content of which is herein incorporated by reference in its entirety for all purposes.

### BACKGROUND

Typically, stereo audio is encoded at a bit rate of 192 kilobits per second (kbps). However, high resolution audio can be encoded at much higher bit rates, such as 900 kbps or greater. In a wireless environment, having to transmit such high bitrate data consumes significantly more bandwidth. Using so much bandwidth for audio transmission can leave little available bandwidth for other purposes. Considering that multiple wireless communication protocols can use the same frequencies, consuming a large amount of bandwidth for audio transmission such as using Bluetooth™ protocol communication can negatively affect communications by a device that uses other communication protocols, such as WiFi™.

### SUMMARY

Various embodiments are described related to a method for audio communications. In some embodiments, a method for audio communications is described. The method may comprise receiving, by a first earbud, an audio packet from an audio source device comprising stereo audio separately encoded as a first channel and a second channel. The method may comprise determining, by the first earbud, that the audio packet was successfully received by the first earbud. The method may comprise determining, by a second earbud, that the audio packet was not successfully received by the second earbud. The method may comprise, in response to determining that the audio packet was not successfully received by the second earbud, transmitting, by the second earbud, a request to the first earbud. The method may comprise in response to the request, transmitting, by the first earbud directly to the second earbud, audio data for only the second channel from the audio packet. The method may comprise outputting by the first earbud, audio for the first channel from the audio packet. The method may comprise outputting, by the second earbud, audio for the second channel from the audio data received from the first earbud.

Embodiments of such a method may include one or more of the following features: the first earbud and the second earbud may be a pair of true wireless earbuds that may not be physically connected with each other. The method may comprise encoding, by the audio source device, the stereo audio as the first channel and the second channel. The first channel and the second channel may be encoded as separate data. The method may comprise transmitting, by the audio source device, the audio packet to the first earbud. The audio packet may be addressed to only a primary earbud. The first earbud may be functioning as the primary earbud and the second earbud may be functionary as a secondary earbud. The method may comprise attempting, by the secondary earbud, to receive the audio packet from the audio source device using encryption credentials of the primary earbud. The method may further comprise establishing, by the primary earbud, a communication session with the audio source device. As part of establishing the communication session, the primary earbud may indicate to the audio source device to encode the first channel and the second channel separately. The first channel and the second channel may be encoded in separate data such that no processing needs to be performed involving data of the first channel to obtain data of the second channel by the first earbud. The audio source device may transmit the audio packet using a connected isochronous stream (CIS) link. The Bluetooth Low Energy™ (LE) communication protocol may be used for communication between the audio source device and the first earbud.

In some embodiments, an audio system is described. The system may comprise a first audio output device. The first audio output device may comprise a first speaker. The first audio output device may comprise a first wireless communication interface. The first audio output device may comprise a first processing system, comprising one or more processors, that may be in communication with the first speaker and the first wireless communication interface. The first processing system may be configured to receive, via the first wireless communication interface, an audio packet from an audio source device comprising stereo audio separately encoded as a first channel and a second channel. The first processing system may be configured to determine that the audio packet was successfully received by the first audio output device. The first processing system may be configured to receive a request from a second audio output device. The first processing system may be configured to, in response to the request, transmit directly to the second audio output device, audio data for only the second channel from the audio packet. The first audio output device may comprise output audio for the first channel from the audio packet via the first speaker. The system may comprise the second audio output device. The second audio output device may comprise a second speaker. The second audio output device may comprise a second wireless communication interface. The second audio output device may comprise a second processing system, comprising one or more processors, that may be in communication with the second speaker and the second wireless communication interface. The second processing system may be configured to determine that the audio packet was not successfully received by the second wireless communication interface. The second processing system may be configured to, in response to determining that the audio packet was not successfully received by the second wireless communication interface, transmit the request to the first audio output device. The second processing system may be configured to receive directly from the first audio output device, audio data for only the second channel from the audio packet. The second processing system may be configured to output audio for the second channel from the audio data received from the first audio output device.

Embodiments of such a system may include one or more of the following features: the first audio output device may be a first earbud and the second audio output device may be a second earbud. The first earbud and the second earbud form a pair of true wireless earbuds that may not be physically connected with each other. The system may further comprise the audio source device. The audio source device may be configured to encode the stereo audio as the first channel and the second channel. The first channel and the second channel may be encoded as separate data. The audio source device may be further configured to transmit the audio packet to the first audio output device. The audio packet may be addressed to only a primary audio output device. The first audio output device may be functioning as the primary audio output device and the second audio output device may be functionary as a secondary audio output device. The second processing system of the second audio output device may be further configured to attempt to receive the audio packet from the audio source device using encryption credentials of the primary audio output device. The first processing system of the first audio output device may be further configured to establish a communication session with the audio source device. As part of establishing the communication session, the primary audio output device may indicate to the audio source device to encode the first channel and the second channel separately. The first channel and the second channel may be encoded in separate data such that no processing needs to be performed involving data of the first channel to obtain data of the second channel by the first audio output device. The audio source device may transmit the audio packet using a connected isochronous stream (CIS) link. Bluetooth Low Energy (LE) may be used for communication between the audio source device and the first audio output device.

In some embodiments, a pair of true wireless earbuds is described. The pair of true wireless earbuds may comprise a first earbud. A first earbud may comprise a first speaker. A first earbud may comprise a first wireless communication interface. A first earbud may comprise a first processing system, comprising one or more processors, that may be in communication with the first speaker and the first wireless communication interface. The first processing system may be configured to receive, via the first wireless communication interface, an audio packet from an audio source device via a connected isochronous (CIS) link of a Bluetooth Low Energy (LE) communication link, the audio packet comprising stereo audio separately encoded as a first channel and a second channel. The first processing system may be configured to determine that the audio packet was successfully received by the first earbud. The first processing system may be configured to receive a request from a second earbud. The first processing system may be configured to, in response to the request, transmit directly to the second earbud, audio data for only the second channel from the audio packet. The first processing system may be configured to output audio for the first channel from the audio packet via the first speaker. The second earbud may comprise a second speaker. The first earbud may not be physically attached with the second earbud. The second earbud may comprise a second wireless communication interface. The second earbud may comprise a second processing system, comprising one or more processors, that may be in communication with the second speaker and the second wireless communication interface. The second processing system may be configured to determine that the audio packet was not successfully received by the second wireless communication interface. The second processing system may be configured to, in response to determining that the audio packet was not successfully received by the second wireless communication interface, transmit the request to the first earbud. The second processing system may be configured to receive directly from the first earbud, audio data for only the second channel from the audio packet. The second processing system may be configured to receive output audio for the second channel from the audio data received from the first earbud.

### BRIEF DESCRIPTION OF THE FIGURES

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an embodiment of an audio communication system in which a high fidelity audio is output by a pair of true wireless earbuds.

FIG. 2 illustrates a block diagram of an embodiment of an audio communication system.

FIG. 3 illustrates an embodiment of an audio system in which true wireless earbuds communicate with each other in addition to communicating with an audio source.

FIG. 4 illustrates an embodiment of communications between an audio source and earbuds using a connected isochronous stream (CIS) link in which audio is transmitted and relayed.

FIGS. 5A and 5B illustrate an embodiment of a method in which only audio data to be output by a particular earbud is relayed in response to a failure to receive an initial transmission.

FIGS. 6A and 6B illustrate another embodiment of a method in which only audio data to be output by a particular earbud is relayed in response to a failure to receive an initial transmission.

### DETAILED DESCRIPTION

Transmitting high resolution audio to true wireless earbuds, which involve two separate earbuds that are not physically connected with each other or with an audio source device, presents a particular challenge. Audio, particularly high resolution audio (e.g., which can be defined based on bit rate, such as 500 kbps, 600 kbps, 900 kbps, or greater) can be bandwidth intensive. Rather than having an audio source device transmit audio to each earbud separately, embodiments detailed herein are focused on arrangements in which, from the audio source device's perspective, audio is transmitted only to a primary earbud. A secondary earbud has the encryption credentials of the primary earbud, thus allowing the secondary earbud to receive and decrypt (or “snoop”) on communications addressed to the primary earbud.

Wireless communication between an audio source device and true wireless earbuds can be subject to interference and attenuation (e.g., cross-body attenuation) significant enough that one earbud may successfully receive an audio packet but the other earbud may not successfully receive the same audio packet. To decrease the amount of bandwidth used, when one earbud successfully receives an audio packet but the other earbud does not, rather than an entirety of the audio data being relayed to the earbud that failed to receive the data, only the portion of the data to be output as audio is relayed.

In some embodiments, the audio source device uses a codec to encode multi-channel audio (e.g., stereo audio, spatial audio) into two separate monophonic channels, with each monophonic channel containing differing audio. The data for these monophonic channels are mutually exclusive. Therefore, certain bits received in an audio packet can be relayed from one earbud to the other earbud without any additional signal processing being necessary on the earbuds to extract the relevant bits. Further, by relaying only the monophonic channel needed by the other earbud, the total amount of data transmitted (and, thus, bandwidth consumed) is decreased.

In other embodiments, the audio source device encodes audio into a joint stereo encoded format. Before performing a relay, the earbud that successfully received the audio packet performs signal processing in order to extract audio data relevant to the earbud that did not successfully receive the data packet. Then only the relevant audio data is relayed to the other earbud for output.

While arrangements detailed herein refer to earbuds and specifically true wireless earbuds, other audio output devices can make use of the embodiments detailed herein. For example, a pair of wireless speakers or hearing aids may make use of the arrangements detailed herein. Further, while high resolution audio is particularly bandwidth-intensive, embodiments detailed herein can be applied to all forms of audio.

Embodiments detailed herein may be performed using Bluetooth Low Energy (LE) and LE Audio. Bluetooth LE makes use of asynchronous connectionless (ACL) links and connected isochronous stream (CIS) links, as detailed herein. In other arrangements, short-range device-to-device communication protocols, other than Bluetooth LE, may be used to employ the same detailed concepts. Embodiments detailed herein are applicable to arrangements in which the audio output system is only outputting audio, such as music playback or audio output by a game. Embodiments detailed herein are also applicable to arrangements in which the audio output system transmits upstream audio in addition to receiving downstream audio, such as an audio conference, video conference, or phone call.

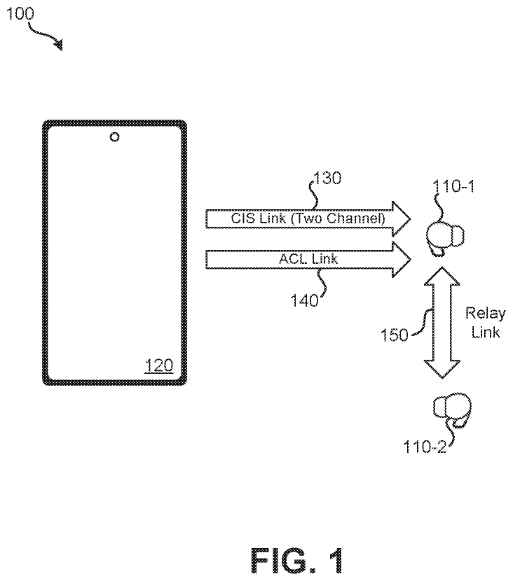

Further detail regarding such arrangements is provided in relation to the figures. FIG. 1 illustrates an embodiment of an audio communication system 100 (“system 100”) in which a high fidelity audio is output by a pair of true wireless earbuds. System 100 can operate according to the Bluetooth Low Energy (LE) communication protocol. Other embodiments may use a wireless short-range device-to-device communication protocol other than Bluetooth LE. System 100 can include: audio source device 120, and an audio output system, such as earbuds 110 (which includes earbud 110-1 and earbud 110-2). Audio source device 120 can be any form of computerized device that transmits wireless packetized audio to be output by an audio output system. Audio source device 120 may be: a smartphone, a gaming device, a computer (e.g., laptop, desktop, server), a tablet computer, a receiver, an amplifier, or some other form of device that streams wireless packetized audio. The audio output system can be a pair of true wireless earbuds. As previously detailed, such wireless earbuds 110 are not physically connected with each other and are not physically connected with audio source device 120. Other forms of an audio output system are possible. For example, wireless speakers, hearing aids, or wireless headphones (which may be physically connected together, but each speaker system of the headphones communicates with each other wirelessly) are possible types of audio output systems.

In system 100, from the perspective of audio source device 120, audio source device 120 is communicating with a single primary earbud, which in this case is represented as earbud 110-1. The primary earbud can be the left or the right earbud. Audio source device 120 streams packetized audio wirelessly to earbud 110-1. This audio stream can be transmitted via CIS link 130, which includes audio for both a left and right channel. In some embodiments, audio source device 120 uses a codec to encode stereo audio as two monophonic audio channels (i.e., a left monophonic audio channel and a right monophonic audio channel). In other embodiments, audio source device 120 uses another codec to encode stereo audio in a joint stereo format. Also present can be an ACL link 140. While CIS link 130 is used for transmitting two channels of audio, ACL link 140 is used for control data.

Earbud 110-2 can have the encryption credentials of earbud 110-1. Therefore, earbud 110-2 can receive and decrypt packets that are addressed to earbud 110-1. While from the perspective of audio source device 120, audio source device 120 is only transmitting packets to earbud 110-1, earbud 110-2 may be attempting to receive and decrypt such packets. As such, an audio packet transmitted by audio source device 120 via CIS link 130 to earbud 110-1 may also be received by earbud 110-2.

If both earbuds 110 successfully receive the packet transmitted on CIS link 130 from audio source device 120, each earbud may extract the audio data necessary for its given channel and output such audio via its speaker. For example, earbud 110-1 can output a right monophonic channel and earbud 110-2 can output a left monophonic channel.

However, a circumstance can arise where one of earbuds 110 does not properly receive the audio packet. If earbud 110-1 does not properly receive the audio packet, it can transmit a negative acknowledgement (“NAK”) to audio source device 120, which triggers audio source device 120 to retransmit the content of the audio packet. However, if earbud 110-2 does not properly receive the audio packet, it may not communicate with audio source device 120. Rather, earbud 110-2 can transmit a request to earbud 110-1. In response to the request, earbud 110-1 can transmit, via relay link 150, to earbud 110-2, audio corresponding to only the audio channel that earbud 110-2 is to output. If the audio data was transmitted as two monophonic channels, earbud 110-1 can relay the bits corresponding to, for example, the left monophonic channel. If the audio data was transmitted to earbud 110-1 in a joint stereo encoded format, earbud 110-1 can perform signal processing to extract audio corresponding to the channel to be output by earbud 110-2, then relay the data corresponding to this channel via relay link 150.

It can also be possible for earbud 110-2 to properly receive the audio packet, but earbud 110-1 fails to properly receive the audio packet from audio source device 120. In such a situation, the reverse can occur where audio data corresponding to only the audio channel to be output by earbud 110-1 is relayed to earbud 110-1 by earbud 110-2.

These arrangements can significantly increase the amount of bandwidth available because: 1) the audio is only initially transmitted to a single earbud by audio source device 120; and 2) even if the audio packet was not successfully received by one of the earbuds from audio source device 120, the other earbud relays only the necessary audio data to the earbud that failed to initially receive from audio source device 120.

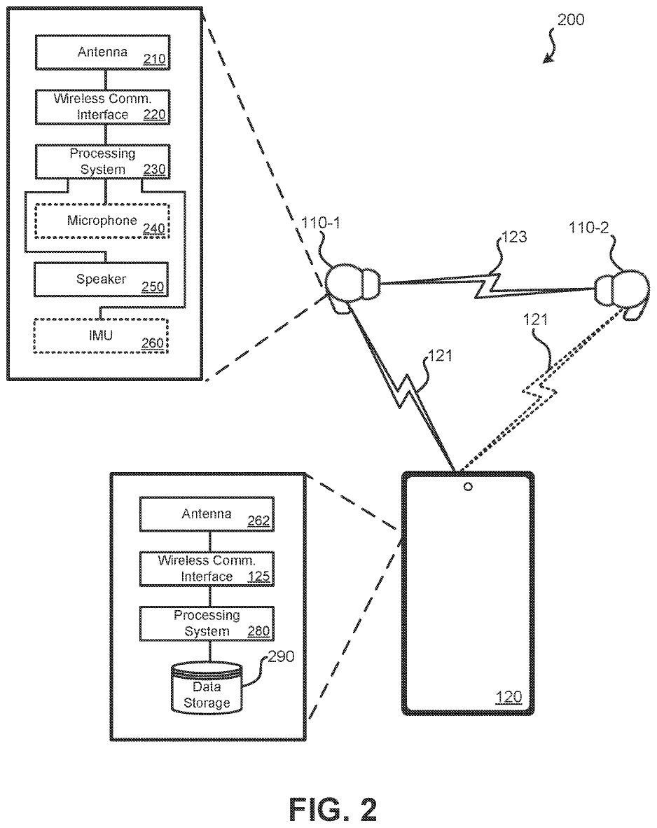

FIG. 2 illustrates an embodiment of a block diagram of a dynamic spatial audio system 200. Dynamic spatial audio system 200 can include earbuds 110 and audio source device 120. System 200 can represent a more detailed embodiment of system 100 of FIG. 1. Referring to earbuds 110, components of earbud 110-1 can include: antenna 210; wireless communication interface 220; processing system 230; microphone 240; speaker 250; and inertial measurement unit (IMU) 260. Earbud 110-2 may have the same components or a subset. For example, some pairs of earbuds may include only one earbud that has microphone 240, IMU 260, or both. Microphone 240 and IMU 260 are optional components. Antenna 210 can be used for receiving and transmitting device-to-device short-range communications, such as Bluetooth-family communications, including basic rate/extended data rate (BR/EDR), and LE (including LE Audio which uses LE). Wireless communication interface 220 can be implemented as a system on a chip (SOC). Wireless communication interface 220 can include a Bluetooth radio and componentry necessary to convert raw incoming data (e.g., audio data, other data) to Bluetooth packets for transmission via antenna 210. A single radio may be present on each of earbuds 110, thus requiring transmissions, even on different frequencies, to occur at different times. Wireless communication interface 220 may also include componentry to enable one or more alternative or additional forms of wireless communication, both with an audio source and between earbuds.

Processing system 230 may include one or more special-purpose or general-purpose processors. Such special-purpose processors may include processors that are specifically designed to perform the functions of the components detailed herein. Such special-purpose processors may be ASICs or FPGAs which are general-purpose components that are physically and electrically configured to perform the functions detailed herein. Such general-purpose processors may execute special-purpose software that is stored locally using one or more non-transitory processor-readable mediums, such as random-access memory (RAM), and/or flash memory. In some embodiments, processing system 230 and wireless communication interface 220 may be part of a same circuit or SOC.

In some earbuds, microphone 240 may be present. In some embodiments, each of earbuds 110 has a microphone. In other embodiments, only one of earbuds 110 has a microphone. In still other embodiments, no microphone may be present in either of earbuds 110. Audio captured using the one or more microphones of earbuds 110 can be transmitted to audio source device 120. This audio, which can be referred to as “upstream” audio, may include voice, such as for use in a telephone call, video conference, gaming, etc. Various componentry (not illustrated) may be present between wireless communication interface 220, processing system 230, and microphone 240, such as an analog to digital converter (ADC) and an amplifier.

Speaker 250 converts received analog signals to audio. Various componentry (not illustrated) may be present between wireless communication interface 220, processing system 230, and speaker 250, such as a digital to analog converter (DAC) and an amplifier.

IMU 260 can be in the form of an accelerometer, gyroscope, or some other form of sensor that can detect movement or acceleration. IMU 260 may measure a direction of gravity, which can be used to determine the IMU's orientation with respect to the direction of gravity. Side-to-side movement can be detected based on acceleration.

Various components of earbud 110-1 are not illustrated. In addition to the ADC, DAC, and amplifiers previously mentioned, earbud 110-1 also includes a power storage component, such as one or more batteries, and associated componentry to allow for recharging of the power storage component. Also present is a housing and componentry to hold earbud 110-1 within a user's ear. One or more non-transitory processor readable mediums can be understood as present and accessible by wireless communication interface 125, processing system 230, or both. For instance, such mediums may be used for temporary storage of data (e.g., buffers) and storing data necessary for Bluetooth communication (e.g., encryption keys).

Audio source device 120 can include: antenna 262; wireless communication interface 125; processing system 280; and data storage 290. Antenna 262 can be used for receiving and transmitting Bluetooth-family communications, including BR/EDR, and LE. Wireless communication interface 125 can be implemented as a system on a chip (SOC). Wireless communication interface 125 can include a Bluetooth radio and componentry necessary to convert raw incoming data (e.g., audio data, other data) to Bluetooth packets for transmission via antenna 262. Wireless communication interface 125 can additionally or alternatively be used for one or more other forms of wireless communications. Processing system 280 may include one or more special-purpose or general-purpose processors. Such special-purpose processors may include processors that are specifically designed to perform the functions of the components detailed herein. Such special-purpose processors may be ASICs or FPGAs which are general-purpose components that are physically and electrically configured to perform the functions detailed herein. Such general-purpose processors may execute special-purpose software that is stored locally using one or more non-transitory processor-readable mediums via data storage 290, which can include random access memory (RAM), flash memory, a hard disk drive (HDD) and/or a solid-state drive (SSD). In some embodiments, processing system 280 and wireless communication interface 125 may be part of a same circuit or SOC.

Audio source device 120 can include various other components. For example, if audio source device 120 is a smartphone, various components such as: one or more cameras, a display screen or touch screen, volume control buttons, or other wireless communication interfaces can be present. Examples of audio source device 120 include: a smartphone; a media player; a gaming device; a computer system (e.g., laptop, desktop, server); a smartwatch; any other computerized device or system which uses short-range device-to-device wireless communication to output audio or output dynamic spatial audio.

In embodiments where true wireless earbuds 110 are used, one earbud, such as earbud 110-1, may function as the primary earbud. From the perspective of audio source device 120, audio source device 120 is only communicating with the primary earbud and, thus, only transmissions 121 are present. Audio to be output by the secondary earbud (for example, earbud 110-2) may be: obtained by receiving and decrypting communication transmitted by audio source device 120 to the primary earbud, by direct communication with the primary earbud via transmissions 123, or some combination thereof. Transmissions 121 can be received (or “snooped”) by earbud 110-2 using the encryption credentials of earbud 110-1.

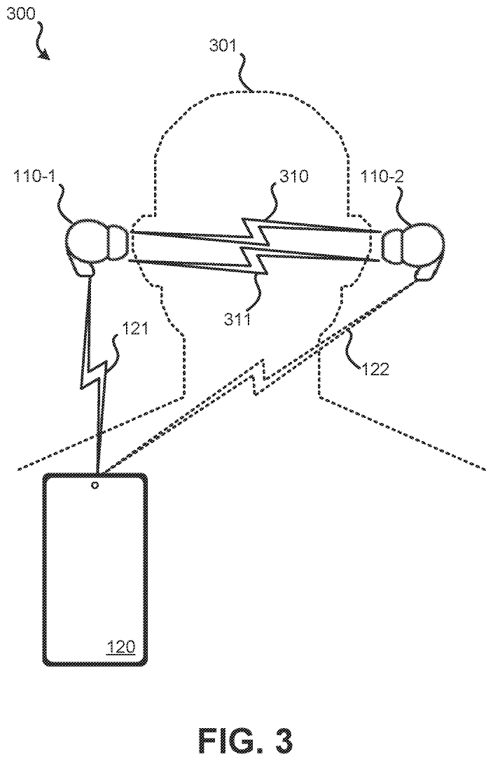

FIG. 3 illustrates an embodiment of an audio system 300 in which true wireless earbuds communicate with each other in addition to communicating with audio source device 120. Audio system 300 can represent an embodiment of system 100. Earbud 110-1 can perform wireless communications using crosslink 310 with earbud 110-2 and, similarly, earbud 110-2 can perform wireless communications using crosslink 311 with earbud 110-1. Crosslinks 310 and 311 collectively represent relay link 150 of FIG. 1. This communication may occur via a proprietary link specific to earbuds 110 and therefore can be outside of any Bluetooth family protocol specification; alternatively, a Bluetooth-family communication protocol can be used. The path between earbuds 110, when in use by user 301, is predictable because the distance and the object through which the signals pass (the head of user 301) remain constant. This path can be expected to produce insufficient attenuation to negatively impact communication between earbuds. The path, however, from audio source device 120 to the earbuds is harder to predict since the position of audio source device 120 relative to earbuds 110 can vary substantially and can result in significantly different attenuation at one earbud compared to the other, such as due to cross-body attenuation. Cross-body attenuation is depicted in FIG. 3 by having audio source device 120 closer to earbud 110-1 than earbud 110-2.

Crosslinks 310 and 311 can use Bluetooth LE 2M, LE HDT (pending standardization), LE proprietary high data rate modes, classic BR/EDR, or some proprietary communication scheme. Therefore, while Bluetooth-compliant wireless communications occur between earbuds 110 and audio source device 120, communications directly between earbuds do not necessarily need to be compliant with Bluetooth or any other particular communication protocol.

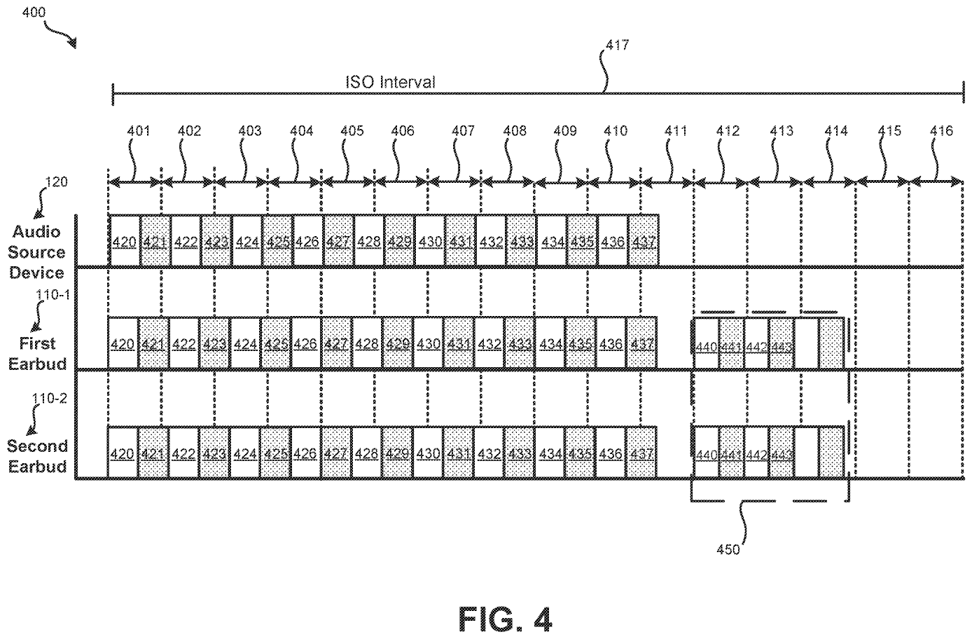

FIG. 4 illustrates an embodiment 400 of communications between an audio source and earbuds using a CIS link in which high resolution audio is transmitted and relayed. In the example of FIG. 4, audio source device 120 transmits a codec frame that is split among multiple packets addressed to first earbud 110-1, which is functioning as the primary earbud. As an example, a codec frame for high resolution audio could be around 1000 bits. However, the maximum packet size may be considerably smaller, such as around 256 bits. Therefore, the codec frame needs to be split among multiple packets. In the illustrated embodiment, ISO interval 417 is 16 frames in duration (frames 401-416), with each frame being 1.25 ms in duration. Therefore, in this example, the ISO interval is 20 ms. As shown in FIG. 4, eight packets (packets 420, 422, 424, 426, 428, 430, 432, 434, and 436) are shown as transmitted by audio source device 120 to the primary earbud, which is first earbud 110-1 in this example. Corresponding to these packets are response packets 421, 423, 425, 427, 429, 431, 433, 435, and 437 transmitted by the primary earbud (earbud 110-1 in embodiment 400) to audio source 120. Some of these represent retransmissions packets and response packets. Therefore, for example, if every transmitted packet is properly received, only packets 420, 422, 424, and 426 may be transmitted, with packets 428-437 only transmitted if needed for retransmissions.

Audio packet 420 may be transmitted by audio source device 120 at the start of frame 401. Within audio packet 420 may be: audio data for two separately encoded monophonic channels; or audio data in a joint stereo encoded format. If audio packet 420 is successfully received by first earbud 110-1, first earbud 110-1 can respond with an acknowledgement (“ACK”) to audio source device 120. Audio packets 422 and 424 may only be transmitted within ISO interval 417 if audio packet 420 was not successfully received by first earbud 110-1 (e.g., first earbud 110-1 did not respond to packet 420 or transmitted a NAK).

Second earbud 110-2 may successfully receive and decrypt audio packet 420 from audio source device 120. While audio packet 420 was addressed to only first earbud 110-1, using encryption credentials for first earbud 110-1, second earbud 110-2 can receive and decrypt audio packet 420. Similarly, if transmitted, second earbud 110-2 can try to receive audio packets 422 and 424. If audio packet 420 was successfully received by both earbuds 110, little communication directly between earbuds 110 may be needed during ISO interval 417. First earbud 110-1, as packet 440, may send an inquiry to second earbud 110-2 as to whether audio data is needed. Reply packet 441 can indicate that no relay of audio data is needed (since the packets transmitted by audio source device 120 were successfully received by second earbud 110-2). Packets 442 and 443 may only be transmitted if a retry is needed.

If second earbud 110-2 did not successfully receive and decrypt at least one of the packets transmitted by audio source device 120, such as audio packets 420, 422, 424, and 426, second earbud 110-2 may rely on first earbud 110-1 to relay audio data. Second earbud 110-2 can transmit packet 440 as a request to first earbud 110-1 for audio data or may transmit a request as part of a reply packet to a query from first earbud 110-1 (e.g., as packet 441 in response to packet 430). The entire codec frame does not need to be relayed, but rather only audio data from the missing frame, such as packet 422. First earbud 110-1 transmits only the audio that is to be output by second earbud 110-2 to second earbud 110-2 (e.g., from missed packet 422). Therefore, if two separately encoded monophonic channels were transmitted by audio source device 120 in packet 422, then the bits from audio packet 422 corresponding to the separately encoded monophonic channel to be output by second earbud 110-2 are extracted and transmitted by first earbud 110-1 to second earbud 110-2. Instead, if audio packet 422 is in a joint stereo encoded format, first earbud 110-1 performs signal processing to isolate data to be transmitted to second earbud 110-2. This data includes only the data necessary to output audio by second earbud 110-2 and removes other data; thus, the amount of data transmitted to second earbud 110-2 is smaller than packet 422.

In other embodiments, second earbud 110-2 may receive, for example, audio packet 422 successfully but first earbud 110-1 may not. The relay of audio data can then be reversed between earbuds, with second earbud 110-2 relaying audio data from only audio packet 422 to be output by first earbud 110-1 to first earbud 110-1. The relay of data between earbuds occurs during one or more unused frames of ISO interval 417. As illustrated, frame 412 is the first fully unused frame if packets 422, 424, 426, 428, 430, 432, 434, and 436 were transmitted by audio source device 120. Frame 412 and, if necessary, one or more subsequent frames such as frame 413, may be used for relay link communications. Following ISO interval 417, a new ISO interval begins with new audio data transmission by audio source device 120 on the CIS link.

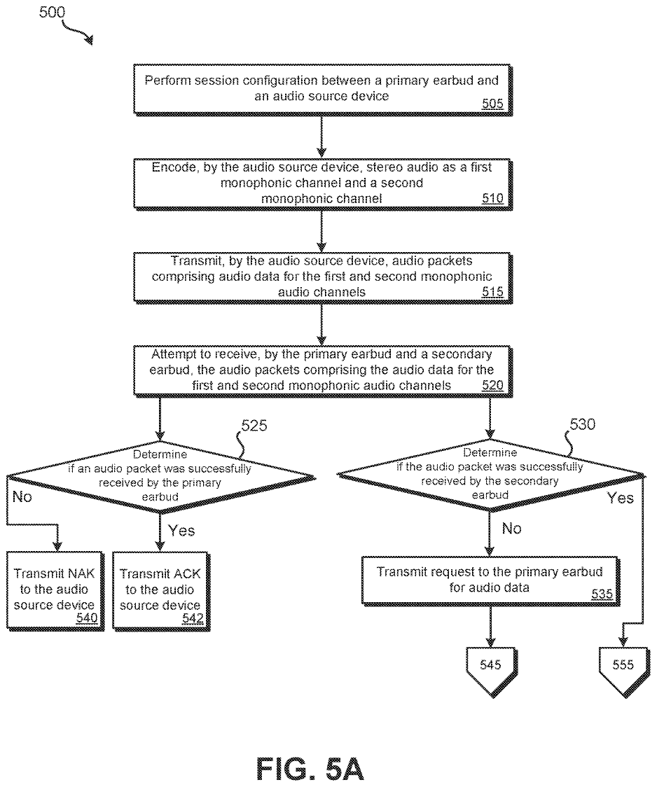

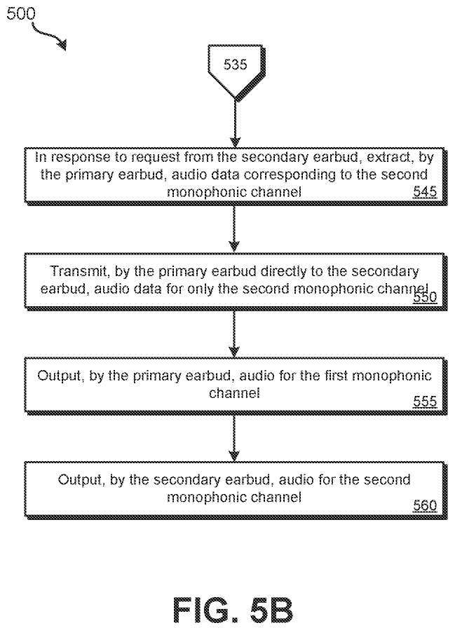

Various methods are performed using the systems and embodiments of FIGS. 1-4. FIGS. 5A and 5B illustrate an embodiment of a method 500 in which only audio data to be output by a particular earbud is relayed in response to a failure to receive an initial transmission. Method 500 involves the use of two separately encoded monophonic channels. Method 500 may be particularly useful when both bandwidth preservation and minimal latency are desired. Method 500 can be performed using the systems of FIGS. 1-3. Method 500 can be performed using Bluetooth LE or some other Bluetooth-family protocol for at least the wireless communication between the primary earbud and the audio source device. In method 500, a codec frame can be significantly larger than a maximum packet size and, thus, the codec frame is broken up across multiple packets. Therefore, in order to transmit a single codec frame, multiple packets are transmitted in method 500.

At block 505, a session configuration is performed between the earbuds and the audio source device. The session configuration can be performed when an active connection is established between the primary earbud and the audio source device (i.e., both devices are powered on and within communication range of each other). For example, in Bluetooth LE, this session configuration is distinct from an initial pairing process that is performed the first time the earbuds are wirelessly connected with the audio source device. The session configuration can be performed between the primary earbud and the audio source device; from the perspective of the audio source device, the audio source device is communicating with only the primary earbud and is unaware of the secondary earbud. During this session configuration or afterwards, one or more encryption keys and an address of the primary earbud may be shared with the secondary earbud to allow the secondary earbud to receive and decrypt or “snoop” on packets transmitted to the primary earbud. As part of the session configuration, the primary earbuds can provide eligible encoding options to the audio source device. The available encoding modes can vary by session, such as due to the earbuds having another concurrent wireless connection with another device. For example, concurrent wireless connections may be present between the earbuds and both a smartphone and a computer. The available encoding options can include an option to encode stereo audio as separately encoded monophonic channels, into a joint stereo encoded format, or both. For the purposes of method 500, the negotiation between the primary earbud and the audio source device results in separately encoded monophonic channels being selected as the encoding mode.

In some embodiments, as part of the session configuration or as part of a separate configuration communication (e.g., via the ACL link), the earbuds may receive information from the audio source indicating that high resolution audio is to be transmitted to the earbuds for output. High resolution audio can be defined as having a bitrate at or above some defined threshold, such as 500, 600, or 900 kbps (or some other selected bitrate). In response to this information, the earbuds may enter into a high resolution audio output mode that helps conserve bandwidth. When not in the high bandwidth mode, blocks of method 500 may not be performed or may be performed differently. For example, if an earbud fails to receive its audio, both channels may be relayed from the other earbud, the audio source device may be triggered to perform a retransmission, or an entirety of a codec frame can be retransmitted. Such steps may not happen in the high resolution audio mode, as detailed in the remainder of method 500.

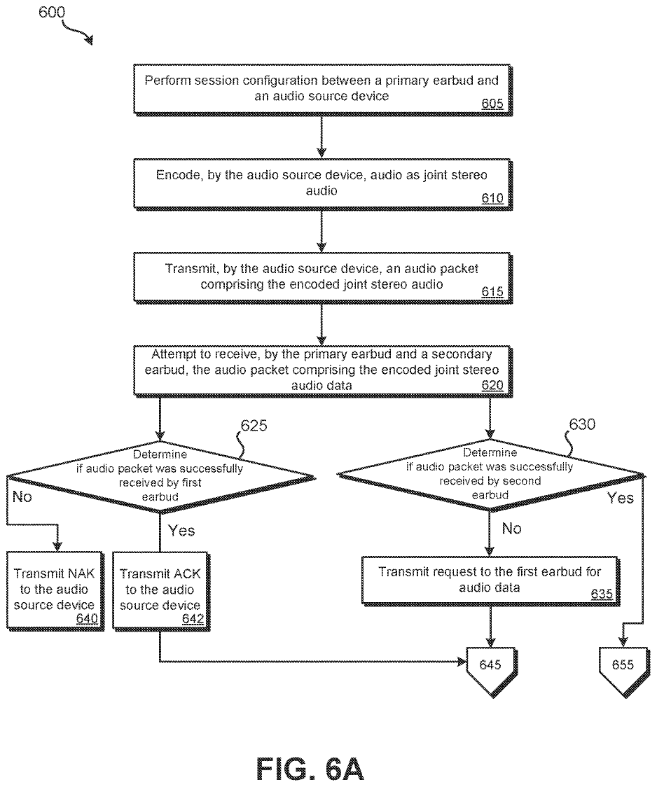

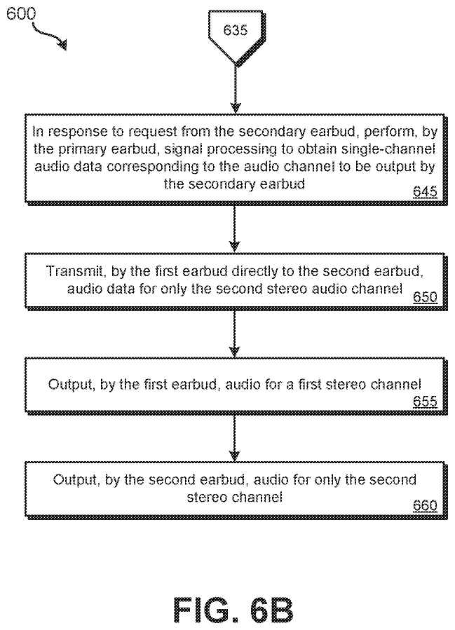

At block 510, the audio source device, based on the session configuration, encodes stereo audio as two separately encoded monophonic audio channels. This decision may have been made by the audio source device based on the available encoding modes. In some embodiments, only a single encoding mode may be available, thus there being no decision to be made by the audio source device. In some embodiments, if a decision is to be made, the audio source device selects the encoding mode based on whether latency needs to be decreased as much as possible. In some embodiments, a particular encoding mode is selected based on an audio-outputting application being executed by the audio source device. As an example, a gaming application may require that low latency audio be output; however, for a music streaming application, latency may be less of a concern. Encoding as separately encoded monophonic channels can allow for latency at the earbuds to be lower compared to other encoding modes, such as detailed in relation to method 600 of FIGS. 6A and 6B. The two separately encoded monophonic audio channels of block 510 are wholly independent of each other; that is, no data from one channel's data is necessary for output of the other channel. Therefore, entirely separate bits represent each channel. Since a codec frame is broken up into multiple packets, packets corresponding to a first monophonic channel may be transmitted followed by packets for the second monophonic channel. The channels of block 510 can generally be understood as being a left and a right channel. The primary earbud can be either the left or right earbud and would thus output the channel corresponding to whether the primary earbud is a left or right earbud.

At block 515, audio packets are transmitted by the audio source device. (Following each transmission of a packet at block 515, at least blocks 525, 530, 540, and 542 may be performed.) Each audio packet is addressed to only the primary earbud and can be transmitted in an encrypted form, such as in accordance with Bluetooth LE. In Bluetooth LE, the audio packet is transmitted via a CIS link to the primary earbud. The audio packet can include data for the first monophonic channel, the second monophonic channel, or both. Each audio packet is then be attempted to be received at block 520 by the primary earbud and the secondary earbud. Ideally, the packet will be properly received by both the primary earbud and the secondary earbud (by using the encryption credentials of the primary earbud). However, due to attenuation (e.g., cross-body attenuation), interference, or some combination thereof, only one of the earbuds may properly receive the packet.

Blocks 525 and 530 may be performed concurrently or approximately concurrently by each earbud. Blocks 525 and 530 can involve attempting decryption and analyzing each received packet (e.g., performing error correction) to determine if the packet was successfully received. At block 525, the primary earbud determines whether a packet attempted to be received at block 520 was successfully received or not. If successfully received, an ACK can be transmitted at block 542 back to the audio source device such that the audio source device does not attempt any retransmissions of the packet. If the packet is not successfully received, a NAK can be transmitted at block 540 back to the audio source device such that the audio source device retransmits the same audio data again. Embodiments in which the primary earbud transmits an ACK even when the audio packet is not successfully received are possible; in such embodiments, the primary earbud can rely on getting the unsuccessfully received audio data from the secondary earbud. In other embodiments, if block 540 is performed, method 500 may return to block 515 and transmit a retransmission of the audio data contained in the missed packet.

At block 530, the secondary earbud determines whether the packet, which is addressed to only the primary earbud, attempted to be received at block 520 was successfully received. If successfully received at block 520, method 500 proceeds to block 555. If not successfully received at block 520, method 500 proceeds to block 535. At block 535, the secondary earbud requests audio data for the one or more missed packets directly from the primary earbud, such as via an ACL link directly between the two earbuds. Notably, the whole codec frame is not requested, only individual one or more packets that were missed. The secondary earbud does not communicate with the audio source device; that is, if it did not successfully snoop the packet transmitted by the audio source device to the primary earbud, the secondary earbud is reliant on the primary earbud for obtaining its audio data. The request transmitted at block 535 can take multiple forms. In some embodiments, the primary earbud can transmit a query packet (e.g., packet 430 of FIG. 4), such as via an ACL link with the secondary earbud, to the secondary earbud. This query packet can indicate whether the primary earbud requires audio data from the secondary earbud and provide the opportunity for the secondary earbud to respond (e.g., packet 431) with an indication of whether the secondary earbud requires audio data from the primary earbud. Alternatively, the secondary earbud may not need the primary earbud to initiate communication. Rather, the secondary earbud, such as using a Bluetooth LE ACL link with the primary earbud, can transmit a query (e.g., packet 430) to the primary earbud requesting audio data, to which the primary earbud can respond (e.g., packet 431) with audio data. Following block 535, method 500 can proceed to block 545 on FIG. 5B.

At block 545, regardless of the form in which the request was directly received from the secondary earbud, the primary earbud is triggered to extract audio data from the packet missed by the secondary earbud. Only data corresponding to the monophonic channel (e.g., second monophonic channel) that is to be output by the secondary earbud is extracted for relay to the secondary earbud. Since the two monophonic channels are separately encoded, extracting the relevant audio data can involve selecting the appropriate bits from the payload of the packet (e.g., decrypted packet) received at block 520 without performing any additional processing involving audio for the other monophonic channel.

If the missed packet does not contain audio data to be output by the secondary earbud (i.e., the audio corresponds to only the monophonic channel to be output by the primary earbud), no audio data may be transmitted to the secondary earbud in response to a request for the missed packet. However, related data may be transmitted, such as data indicative of a length of audio data in the packet. The length of data may be important to allow the secondary earbud to determine a location in the codec frame transmitted across multiple packets where audio data begins for the secondary earbud. While the data itself is not needed, the length is needed in order to properly locate the secondary earbud's audio data transmitted in later packets.

At block 550, the first earbud transmits, directly to the secondary earbud, such as via the Bluetooth LE ACL link, the missed audio data that corresponds to only the monophonic channel to be output by the secondary earbud as one or more packets, as necessary. These one or more packets may also be encrypted, which may use a separate set of encryption keys, which will then be decrypted by the secondary earbud. In response to successfully receiving these one or more packets, the secondary earbud can transmit an ACK to the primary earbud. If not successfully received, a NAK may be transmitted and at least one retry of sending the same data may be possible within the same ISO interval in which the packet of block 515 was transmitted.

At block 555, audio is created and output via a speaker of the primary earbud using the audio data for its monophonic channel (e.g., the first monophonic channel) based on the audio data received in the packet of block 515. At block 560, audio is created and output via a speaker of the secondary earbud using the audio data for its monophonic channel (e.g., the second monophonic channel) based on the audio data it received at block 550 from the primary earbud.

While the above description is focused on the arrangement in which the primary earbud properly receives an audio packet from the audio source device and the secondary earbud fails to receive (or “snoop”) on the audio packet, the reverse arrangement can also be possible in which the audio packet is successfully received by the secondary earbud and one channel of the monophonic audio channels is relayed to the primary earbud, which failed to initially receive the audio packet.

FIGS. 6A and 6B illustrate an embodiment of method 600 in which only audio data to be output by a particular earbud is relayed in response to a failure to receive an initial transmission. Method 600 involves the use of joint stereo encoding. Method 600 may be particularly useful when bandwidth preservation is desired and latency is less of a concern, such as for music streaming. Method 600 can be performed using the systems of FIGS. 1-3. Method 600 can be performed using Bluetooth LE or some other Bluetooth-family protocol for at least the wireless communication between the primary earbud and the audio source device. Notably, method 600 refers to a single packet. However, a codec frame can be significantly larger than a maximum packet size and, thus, is broken up across multiple packets. Therefore, in order to transmit a single codec frame, method 600 needs to be performed multiple times.

At block 605, a session configuration is performed between the earbuds and the audio source device. The session configuration can be performed when an active connection is established between the primary earbud and the audio source device (i.e., both devices are powered on and within communication range of each other). For example, in Bluetooth LE, this session configuration is distinct from an initial pairing process that is performed the first time the earbuds are wirelessly connected with the audio source device. The session configuration can be performed between the primary earbud and the audio source device; from the perspective of the audio source device, the audio source device is communicating with only the primary earbud and is unaware of the secondary earbud. During this session configuration or afterwards, one or more encryption keys and an address of the primary earbud may be shared with the secondary earbud to allow the secondary earbud to receive and decrypt or “snoop” on packets transmitted to the primary earbud. As part of the session configuration, the primary earbuds can provide eligible encoding options to the audio source device. The available encoding modes can vary by session, such as due to the earbuds having another concurrent wireless connection with another device. For example, concurrent wireless connections may be present between the earbuds and both a smartphone and a computer. The available encoding options can include an option to encode stereo audio as separately encoded monophonic channels, a joint stereo audio, or both. For the purposes of method 500, the negotiation between the primary earbud and the audio source device results in joint stereo audio being selected as the encoding mode. In a joint stereo audio encoding format, two channels of audio are present and encoded together. As such, individual bits of the joint stereo encoded data can be relevant to both audio channels. To exact a single audio channel from the joint stereo audio data, signal processing needs to be performed.

In some embodiments, as part of the session configuration or as part of a separate configuration communication (e.g., via the ACL link), the earbuds may receive information from the audio source indicating that high resolution audio is to be transmitted to the earbuds for output. High resolution audio can be defined as having a bitrate at or above some defined threshold, such as 600 kbps. In response to this information, the earbuds may enter into a high resolution audio output mode that helps conserve bandwidth. When not in the high bandwidth mode, blocks of method 600 may not be performed or may be performed differently. For example, if an earbud fails to receive its audio, both channels may be relayed from the other earbud or the audio source device may be triggered to perform a retransmission. Such steps may not happen in the high resolution audio mode, as detailed in the remainder of method 600.

At block 610, the audio source device, based on the session configuration, encodes stereo audio in a joint stereo audio format. This decision may have been made by the audio source device based on the available encoding modes. In some embodiments, only a single encoding mode may be available, thus there is no decision to be made by the audio source device. In some embodiments, if a decision is to be made, the audio source device selects the encoding mode based on whether latency needs to be decreased as much as possible. In some embodiments, a particular encoding mode is selected based on an audio-outputting application being executed by the audio source device. As an example, a gaming application may require that low latency audio be output; however, for a music streaming application, latency may be less of a concern. Encoding using joint stereo audio encoding may result in higher latency at the earbuds compared to other encoding modes, such as detailed in relation to method 500 of FIGS. 5A and 5B. However, this encoding mode may be sufficient for the application outputting the audio or may be the only audio encoding arrangement available.

At block 615, an audio packet is transmitted by the audio source device. The audio packet is addressed to only the primary earbud and can be transmitted in an encrypted form, such as in accordance with Bluetooth LE. In Bluetooth LE, the audio packet is transmitted via a CIS link to the primary earbud. The audio packet includes the encoded joint stereo audio data. The audio packet can then be attempted to be received by the primary earbud and the secondary earbud at block 620. Ideally, the packet will be properly received by the primary earbud and the secondary earbud (by using the encryption credentials of the primary earbud). However, due to attenuation (e.g., cross-body attenuation), interference, or some combination thereof, only one of the earbuds may properly receive the packet.

Blocks 625 and 630 may be performed concurrently or approximately concurrently by each earbud. Blocks 625 and 630 can involve attempting decryption and analyzing the packets (e.g., performing error correction) to determine if the packet was successfully received. At block 625, the primary earbud determines whether the packet attempted to be received at block 620 was successfully received or not. If successfully received, an ACK can be transmitted at block 642 back to the audio source device such that the audio source device does not attempt any retransmissions. If the packet is not successfully received, a NAK can be transmitted at block 640 back to the audio source device such that the audio source device retransmits the same audio data again. Embodiments in which the primary earbud transmits an ACK even when the audio packet is not successfully received are possible; in such embodiments, the primary earbud can rely on getting the unsuccessfully received audio data from the secondary earbud. In other embodiments, if block 640 is performed, method 600 may return to block 615.

At block 630, the secondary earbud determines whether the packet, which is addressed to only the primary earbud, attempted to be received at block 620 was successfully received. If successfully received at block 620, method 600 proceeds to block 655. If not successfully received at block 620, method 600 proceeds to block 635. At block 635, the secondary earbud requests audio data directly from the primary earbud, such as via an ACL link directly between the two earbuds. The secondary earbud does not communicate with the audio source device; that is, if it did not successfully snoop the packet transmitted by the audio source device to the primary earbud, the secondary earbud is reliant on the primary earbud for obtaining its audio data. The request transmitted at block 635 can take multiple forms. In some embodiments, the primary earbud can transmit a query packet (e.g., packet 430 of FIG. 4), such as via an ACL link with the secondary earbud, to the secondary earbud. This query packet can indicate whether the primary earbud requires audio data from the secondary earbud and provide the opportunity for the secondary earbud to respond (e.g., packet 431) with an indication of whether the secondary earbud requires audio data from the primary earbud. Alternatively, the secondary earbud may not need the primary earbud to initiate communication. Rather, the secondary earbud, such as using a Bluetooth LE ACL link with the primary earbud, can transmit a query (e.g., packet 430) to the primary earbud requesting audio data, to which the primary earbud can respond (e.g., packet 431) with audio data. Following block 635, method 600 can proceed to block 645 on FIG. 6B.

At block 645, regardless of the form in which the request was directly received from the secondary earbud, the primary earbud is caused to extract audio data from the received packet corresponding to only the audio channel to be output by the secondary earbud. Since the audio data was encoded as joint stereo data, signal processing must be performed by the primary earbud to extract and create audio data corresponding to only the audio channel to be output by the secondary earbud. This signal processing can include an audio subsystem of the primary earbud decoding from the joint stereo data and creating a monophonic channel for the secondary earbud in an appropriate format. This reencoded data is then transmitted to the secondary earbud. The size of created audio data can be expected to be significantly smaller than the payload of the audio packet received at block 620. Additional time may be required to perform the signal processing; thus latency may be increased compared to method 500. If additional time is needed, rather than relaying the audio data during the same ISO interval, the audio data may be relayed during a later ISO interval after the signal processing is performed.

At block 650, the first earbud transmits, directly to the secondary earbud, such as via the Bluetooth LE ACL link, audio data that corresponds to only the reencoded audio channel to be output by the secondary earbud. Therefore, the payload of this packet between the earbuds should be approximately half the number of bits as the packet of block 615. This transmitted packet may also be encrypted, which may use a separate set of encryption keys, which will then be decrypted by the secondary earbud. In response to successfully receiving this packet, the secondary earbud can transmit an ACK to the primary earbud. If not successfully received, a NAK may be transmitted and at least one retry of sending the same data may be possible within the same ISO interval in which the packet of block 615 was transmitted.

At block 655, audio is created and output via a speaker of the primary earbud using the audio data for its audio channel from the encoded joint stereo data received in the packet of block 515. At block 660, audio is created and output via a speaker of the secondary earbud using the reencoded audio data for only its channel to be output that it received at block 650 from the primary earbud.

While the above description is focused on the arrangement in which the primary earbud properly receives an audio packet from the audio source device and the secondary earbud fails to receive or snoop on the audio packet, the reverse arrangement can also be possible in which the audio packet is successfully received by the secondary earbud and one channel of the monophonic audio channels is relayed to the primary earbud, which failed to initially receive the audio packet.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known, processes, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method for audio communications, the method comprising:
receiving, by a first earbud, an audio packet from an audio source device comprising audio separately encoded as a first channel and a second channel;
determining, by the first earbud, that the audio packet was successfully received by the first earbud;
determining, by a second earbud, that the audio packet was not successfully received by the second earbud;
in response to determining that the audio packet was not successfully received by the second earbud, transmitting, by the second earbud, a request to the first earbud;
in response to the request, transmitting, by the first earbud directly to the second earbud, audio data for only the second channel from the audio packet;
outputting by the first earbud, audio for the first channel from the audio packet; and
outputting, by the second earbud, audio for the second channel from the audio data received from the first earbud.

2. The method for audio communications of claim 1, wherein the first earbud and the second earbud are a pair of true wireless earbuds that are not physically connected with each other.

3. The method for audio communications of claim 1, further comprising:
encoding, by the audio source device, the stereo audio as the first channel and the second channel, wherein the first channel and the second channel are encoded as separate data.

4. The method for audio communications of claim 1, further comprising:
transmitting, by the audio source device, the audio packet to the first earbud, wherein:
the audio packet is addressed to only a primary earbud; and
the first earbud is functioning as the primary earbud and the second earbud is functionary as a secondary earbud.

5. The method for audio communications of claim 4, further comprising:
attempting, by the secondary earbud, to receive the audio packet from the audio source device using encryption credentials of the primary earbud.

6. The method for audio communications of claim 5, further comprising:
establishing, by the primary earbud, a communication session with the audio source device, wherein as part of establishing the communication session, the primary earbud indicates to the audio source device to encode the first channel and the second channel separately.

7. The method for audio communications of claim 1, wherein the first channel and the second channel are encoded in separate data such that no processing needs to be performed involving data of the first channel to obtain data of the second channel by the first earbud.

8. The method for audio communications of claim 1, wherein the audio source device transmits the audio packet using a connected isochronous stream (CIS) link.

9. The method for audio communications of claim 8, wherein the communications between the audio source device and first earbud use Bluetooth Low Energy (LE) communication protocol.

10. An audio system, comprising:
a first audio output device, comprising:
a first speaker;
a first wireless communication interface; and
a first processing system, comprising one or more processors, that is in communication with the first speaker and the first wireless communication interface, wherein the first processing system is configured to:
receive, via the first wireless communication interface, an audio packet from an audio source device comprising stereo audio separately encoded as a first channel and a second channel;
determine that the audio packet was successfully received by the first audio output device;
receive a request from a second audio output device;
in response to the request, transmit directly to the second audio output device, audio data for only the second channel from the audio packet;
output audio for the first channel from the audio packet via the first speaker; and
the second audio output device, comprising:
a second speaker;
a second wireless communication interface; and
a second processing system, comprising one or more processors, that is in communication with the second speaker and the second wireless communication interface, wherein the second processing system is configured to:
determine that the audio packet was not successfully received by the second wireless communication interface;
in response to determining that the audio packet was not successfully received by the second wireless communication interface, transmit the request to the first audio output device;
receive directly from the first audio output device, audio data for only the second channel from the audio packet; and
output audio for the second channel from the audio data received from the first audio output device.

11. The audio system of claim 10, wherein the first audio output device is a first earbud and the second audio output device is a second earbud.

12. The audio system of claim 11, wherein the first earbud and the second earbud form a pair of true wireless earbuds that are not physically connected with each other.

13. The audio system of claim 10, further comprising the audio source device, wherein the audio source device is configured to:
encode the stereo audio as the first channel and the second channel, wherein the first channel and the second channel are encoded as separate data.

14. The audio system of claim 13, wherein the audio source device is further configured to:
transmit the audio packet to the first audio output device, wherein:
the audio packet is addressed to only a primary audio output device; and
the first audio output device is functioning as the primary audio output device and the second audio output device is functioning as a secondary audio output device.

15. The audio system of claim 14, wherein the second processing system of the second audio output device is further configured to:
attempt to receive the audio packet from the audio source device using encryption credentials of the primary audio output device.

16. The audio system of claim 15, wherein the first processing system of the first audio output device is further configured to:
establish a communication session with the audio source device, wherein
as part of establishing the communication session, the primary audio output device indicates to the audio source device to encode the first channel and the second channel separately.

17. The audio system of claim 10, wherein the first channel and the second channel are encoded in separate data such that no processing needs to be performed involving data of the first channel to obtain data of the second channel by the first audio output device.

18. The audio system of claim 10, wherein the audio source device transmits the audio packet using a connected isochronous stream (CIS) link.

19. The audio system of claim 18, wherein communication between the audio source device and the first audio output device uses the Bluetooth™ Low Energy (LE) communication protocol.

20. A pair of true wireless earbuds, comprising:
a first earbud, comprising:
a first speaker;
a first wireless communication interface; and
a first processing system, comprising one or more processors, that is in communication with the first speaker and the first wireless communication interface, wherein the first processing system is configured to:
receive, via the first wireless communication interface, an audio packet from an audio source device via a connected isochronous (CIS) link, the audio packet comprising audio separately encoded as a first channel and a second channel;
determine that the audio packet was successfully received by the first earbud;
receive a request from a second earbud;
in response to the request, transmit directly to the second earbud, audio data for only the second channel from the audio packet;
output audio for the first channel from the audio packet via the first
the second earbud, comprising:
a second speaker, wherein the first earbud is not physically attached with the second earbud;
a second wireless communication interface; and
a second processing system, comprising one or more processors, that is in communication with the second speaker and the second wireless communication interface, wherein the second processing system is configured to:
determine that the audio packet was not successfully received by the second wireless communication interface;
in response to determining that the audio packet was not successfully received by the second wireless communication interface, transmit the request to the first earbud;
receive directly from the first earbud, audio data for only the second channel from the audio packet; and
output audio for the second channel from the audio data received from the first earbud.
